(19) United States
(12) Patent Application Publication
(10) Pub. No.: US 2025/0321915 A1
(43) Pub. Date: Oct. 16, 2025

(54) 10BASE-T1S TRANSCEIVER REGISTER ACCESS USING CONTROLLER REMAPPING

(71) Applicant: Microchip Technology Incorporated, Chandler, AZ (US)

(72) Inventors: Venkatraman Iyer, Austin, TX (US); Shuo Yang, Stutensee (DE); Thomas Schroeder, Austin, TX (US); Xin Zhang, Austin, TX (US); Jan Huber, Karlsruhe (DE)

(21) Appl. No.: 19/051,351

(22) Filed: Feb. 12, 2025

Related U.S. Application Data
(60) Provisional application No. 63/634,797, filed on Apr. 16, 2024.

(51) Int. Cl. G06F 13/40; H04L 69/08

(52) U.S. Cl. CPC G06F 13/4068; G06F 13/404; H04L 69/08

(57) ABSTRACT

An apparatus having a controller of a physical layer (PHY) and a transceiver of the PHY controller. The controller includes memory with an address space local to the controller and address space assigned to the transceiver that mirrors register locations in the memory of the transceiver. The controller remaps a frame in a first format, based at least in part on an indication that an access operation is directed to the transceiver register space, to a frame in a second format to access the transceiver registers of the second memory space.

### CROSS-REFERENCE TO RELATED APPLICATIONS

This application claims the benefit under 35 U.S.C. § 119 (e) of the priority date of U.S. Provisional Patent Application Ser. No. 63/634,797, filed Apr. 16, 2024, for 10BASE-TIS Transceiver Register Access Using Controller Remapping, the contents and disclosure of which is incorporated herein in its entirety by this reference.

### BACKGROUND

Automotive networks is a rapidly expanding area of Ethernet communications also known as Ethernet Industrial Protocol (IP). The increasing number of automotive functions and sensors within a vehicle give rise to complex electronic control units (ECUs) that require efficient connections between the ECUs and Ethernet Internet Protocol (IP) to achieve data transfer between ECUs at as high a speed as possible. The cable is the physical part of the Ethernet that connects ECUs using various communication protocols to access and transfer data between devices, such as, without limitation, sensors, cameras, actuators and security systems. Transmitting data over twisted pairs of copper wires, also known as single-pair Ethernet, is one common layout or topology. Single pair Ethernet enables the transmission of data at a minimum rate of 10 Megabits per second (Mbps), an intermediate rate of 100 Mbps, and a maximum rate of 1 Gigabit per second (Gbps). Single pair Ethernet may be grouped together to enable faster data speeds.

In order to standardize Ethernet communications in the automotive industry, automotive standards based on the Institute of Electrical and Electronics Engineers (IEEE) 802.3 standard were developed by OPEN (One-Pair-Ether-Net) Alliance. OPEN Alliance (OA) is a special interest group comprised of automotive technology providers, firms, consultants and companies that work together to set standards for connections and communications in Ethernet-based networks in automobiles.

AUTOSAR® (AUTomotive Open System Architecture) is another partnership between leading international automotive companies to establish standards for software and architecture in automotive applications to enable the development of cohesive applications and standard hardware interfaces and functions across the automotive industry.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram that illustrates a system including an Ethernet physical layer (PHY) apparatus in accordance with one or more examples;

FIG. 2 is a diagram that illustrates states of operation for the PHY according to one or more examples;

FIG. 3 is a diagram that provides a timing sequence according to one or more examples;

FIG. 4 is a state diagram that describes transitions that may occur to implement a locking mechanism according to one or more examples;

FIGS. 5A, 5B, and 5C are flowcharts that illustrate a method of operating according to one or more examples; and

FIG. 6 is a diagram of a system diagram that may be used to implement various functions, operations, acts, processes, or methods disclosed herein.

### DETAILED DESCRIPTION

In the following detailed description, reference is made to the accompanying drawings, which form a part hereof, and in which are shown, by way of illustration, specific examples that may be practiced. These examples are described in sufficient detail to enable a person of ordinary skill in the art to practice the present disclosure. However, other examples may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example of this disclosure to the specified components, acts, features, functions, or the like.

It will be readily understood that the components of the examples as generally described herein and illustrated in the drawing could be arranged and designed in a wide variety of different configurations. Thus, the following description of various examples is not intended to limit the scope of the present disclosure but is merely representative of various examples. While the various aspects of the examples may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the examples disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 50% met, at least 95% met, or even at least 99% met.

As used herein, any relational term, such as “over,” “under,” “on,” “underlying,” “upper,” “lower,” without limitation, is used for clarity and convenience in understanding the disclosure and accompanying drawings and does not connote or depend on any specific preference, orientation, or order, except where the context clearly indicates otherwise.

In this description the term “coupled,” and derivatives thereof, may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The term “connected” may be used in this description interchangeably with the term “coupled,” and has the same meaning unless expressly indicated otherwise or the context would indicate otherwise to a person having ordinary skill in the art.

An Ethernet Physical layer (PHY) may include sublayers having different responsibilities to ensure effective and accurate data transmission. Sublayers may include, without limitation, a physical coding sublayer (PCS), a physical medium attachment (PMA) sublayer, and a physical medium dependent (PMD) sublayer. In one or more examples, the PCS, PMA and PMD sublayers comprise a 10 BASE-TIS PHY.

In one or more examples, a station management entity, such as, without limitation, a media access controller (MAC), or firmware application, may interface to an apparatus having a split functionality using a standard IEEE 802.3 clause 45 protocol having a split functionality. The split functionality of the apparatus may comprise a digital controller portion of the PHY that includes some or a totality of the PHY functionalities of a PCS layer and a PMA sublayer. A transceiver portion of the PHY may include some or a totality of the PMD layer functionality of the PHY. The apparatus may translate or remap the STA operation that may be compliant with the IEEE 802.3 clause 45 protocol or extended clause 22 protocol to an IEEE 802.3 clause 22 protocol to access registers located in the transceiver portion of the PHY. The controller controls the protocols for read and write accesses to memory register space in the PHY. Am application or station management entity may interface with the PHY without regard to the split functionality. The PHY controller may translate or remap read and write accesses to the PHY from a station management entity such as, without limitation, a media access controller, or firmware application, from a first protocol to a to a second protocol compatible with. The PHY control may receive a read or write access utilizing a first protocol and destined for memory locations in the PHY transceiver using a protocol compatible with the interface configuration. In one or more examples, the functionality of a PHY may be split or, for example, without limitation, partitioned, between a digital controller and a separate transceiver, wherein a separate transceiver may indicate that the transceiver is positioned external to the digital controller. The digital controller is interfaced to the transceiver to implement the PHY. The digital PHY controller may be dedicated to some or a totality of the PHY functionalities of a PCS layer and a PMA sublayer, without limitation. The PCS functionalities may include station management (STA), reset, transmit and receive operations. A controller, or station management entity, such as without limitation, a media access controller (MAC) may include station management (STA) operations such as, without limitation, snoop, write access, and read access, to communicate with the PHY. A transceiver of the PHY may interface to a physical medium of an external network such as, without limitation, a modular bus, a network of management data input output (MDIO) manageable devices (MMDs), or a combination thereof, to receive data from and transmit data to the PHY controller. The PHY transceiver may be part of the PMD layer functionality of the PHY, which may define the transmission and reception of bits through the transceiver.

The PHY controller may receive a read or write access transaction destined for the PHY utilizing a first protocol. In one or more examples, the PHY may remap and overlay the access transaction for a physical register of the PHY transceiver based on a protocol compatible with an internal interface configuration between the PHY controller and the PHY transceiver.

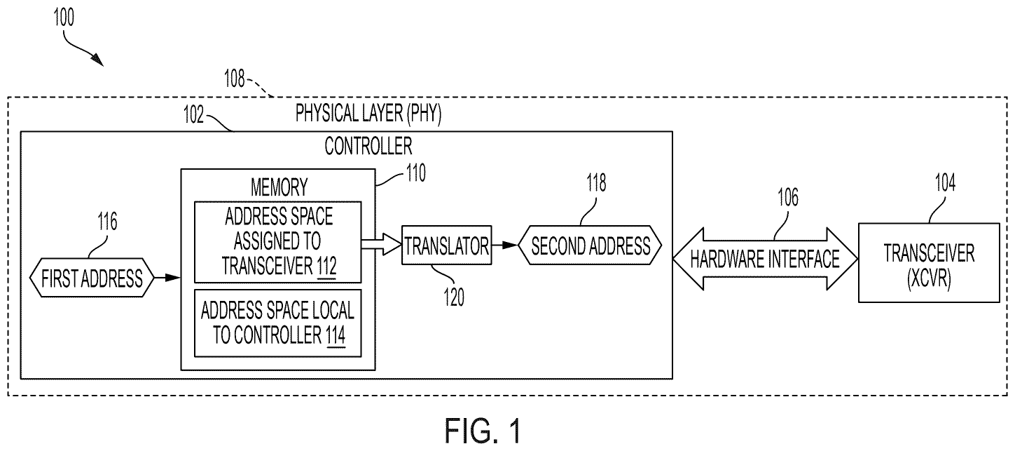

Turning to FIG. 1, a block diagram illustrates a controller remapping sequence, in accordance with one or more examples. Apparatus 100 may represent a PHY 108 of the Ethernet that includes a controller 102, a transceiver (XCVR) 104, a hardware interface 106, a physical layer 108, and an address space, which includes an address space assigned to the transceiver 112 and an address space of the PHY 114. The controller 102 may include a first address 116 that is translated to a second address 118 by a remapper or translator 120. The transceiver 104 may be controlled by or captive to the controller 102 through hardware interface 106. It must be noted that although the controller 102, transceiver 104, and hardware interface 106 are illustrated as being part of a single monolithic PHY block, in one or more examples, the PHY 108 may be split among multiple blocks respectively dedicated to separately processing applications or operations; although an MAC or STA may treat the PHY 108 (e.g., interface to the PHY 108, without limitation) as if it were one monolithic unit, abstracting away the internal architecture.

In the specific non-limiting example depicted by FIG. 1, PHY 108 includes controller 102 and transceiver 104, each integrated with a hardware interface 106. Alternatively, it is specifically contemplated, by way of non-limiting example, that a PHY 108 may include a controller 102 that is digitally configured and integrated with a hardware interface 106, and the digital controller PHY 102 may interface with a transceiver 104, external to the PHY 108, but that is controlled by or captive to the digital controller 102 of the PHY 108 through the integrated hardware interface 106.

In a contemplated operation, the digital controller 102 may receive a first address 116. The controller 102 may determine to translate the first address 116 to a second address 118. The first address 116 and second address 118 may be compatible with IEEE 802.3 clause 22 or clause 45 formats. The translation may be done by, optionally, a remapper 120. The first address 116 and the second address 118 may be part of a memory 110. Memory 110 may be part of physical memory or virtual memory or a portion of both physical and virtual memory. In one or more non-limiting examples, memory 110 may include an address space assigned to the transceiver 112 and an address space local to the controller 114. The transceiver 104 may input and/or output data to and from hardware interface 106.

In one or more non-limiting examples, the controller 102 may receive an I/O access from a station management device or application. A first address 116 value may allow access to the address space of the PHY 114. The value of the first address may be within the address space of the controller 114 or within the address space assigned to the transceiver 112. The controller 102 of the PHY 108 may detect whether the value of the first address 116 is within a physical address space assigned to the transceiver 112. If the first address value is within the address space of the transceiver 112, the controller may remap or translate the first address 116 to a second address 118 that is in a format compatible with the address space of the transceiver. The second address 118 may have a value that is different from the value of the first address 116. In one or more non-limiting examples, the controller may determine that the first address 116 value is not within the address space assigned to the transceiver 112 and perform an I/O access, that is a read or write operation, that does not require a remap of the address or data. In one or more non-limiting alternative examples, a write to the address space of the PHY 114 that is not in the address space of the transceiver 112 may result in a write both to the address in the controller and remapped or translated to a specific address in the transceiver 112. Additionally, a write to an address in the address space of the transceiver 112 may be mirrored into an address of the PHY 114 that is not in the address space of the transceiver 112. Access to the address space of the transceiver 112 may result in a mirroring function in addition to a remapping function. Mirroring is a function that allows the PHY controller to replicate (i.e., mirror) a state of the transceiver.

The second address 118 may have a format that is different from the first address 116. The format of the first address 116 may be compatible with, for example, an automotive Ethernet protocol. In one or more non-limiting examples, the automotive Ethernet protocol may correspond to a 10BASE-TIS IEEE 802.3 protocol. The automotive Ethernet protocol may be part of an AUTOSAR® standardized communication protocol that specifies how devices within an automotive network communicate with each other or access registers within a network. Herein, the IEEE 802.3 standard may also be referred to as “clause 45.” The AUTOSAR® compatible version of clause 45 may be referred to herein as “clause 22 annex D,” “annex 22D,” or more generally “clause 22 extension.” Herein, the term terms “annex 22D,” “clause 22D,” “clause 22 Annex D,” and “clause 22 extension” may be used interchangeably to mean the AUTOSAR® compatible version of clause 45 (C45) based on the IEEE 802.3 clause 22 standard.

The format of the second address 118 may be compatible with a Station Management Interface (STA), commonly referred to as Management Data Input/Output (MDIO) The MDIO interface consists of a serial data I/O line and a clock line, management data clock (MDC). The MDIO may be one of a number of serial bus protocols that may be used to transfer a frame of information across hardware interface 106 to transceiver 104. The MDIO protocol may include read and write access formats that are compliant with IEEE 802.3 clause 22 (C22) STA transactions. In a C22 access request to memory, a single frame configured to include a 5-bit device address value, a 5-bit register address value and a 16-bit data field may be input. This frame configuration would allow for 32 unique device register addresses, and 32 unique register addresses on a shared STA interface. An MDIO-compatible or C45 access may extend the addressing capability of an input frame using 16 bits of address. In an MDIO C45 access, an access request may send a frame that may include a 16-bit address field that may include the address of a register in the addressed device.

In one or more non-limiting examples, the hardware interface 106 may be compatible with an Open Alliance Technical Committee 14 (TC14) PMD protocol and a MDIO bus protocol. Alternatively, in one or more non-limiting examples, the circuitry of hardware interface 106 may be configured to implement a TC14 protocol or an MDIO protocol for the interface. The Open Alliance TC14 scope includes defining the interface specifications for IEEE 802.3 10BASE-TIS designs.

The hardware interface 106 may be configured by the STA interface as an MDIO compatible interface with an I/O data line and a management data clock (MDC). The MDC may be of a suitable frequency to ensure proper synchronization and data transfer between controller 102 and transceiver 104 (e.g., around 25 MHZ, without limitation). When configured as an MDIO interface, hardware interface 106 may send the translated second address 118 and data payload (not shown) in a C22 frame format to a designated address space assigned to the transceiver 112. It must be noted that although only a single apparatus 100 is illustrated by FIG. 1, multiple apparatuses 100 may interface multiple stations or nodes with a bus or physical medium in multidrop configuration. The multidrop configuration is a feature of 10BASE-TIS automotive Ethernet technology and allows multiple devices to be connected to the same bus or physical medium.

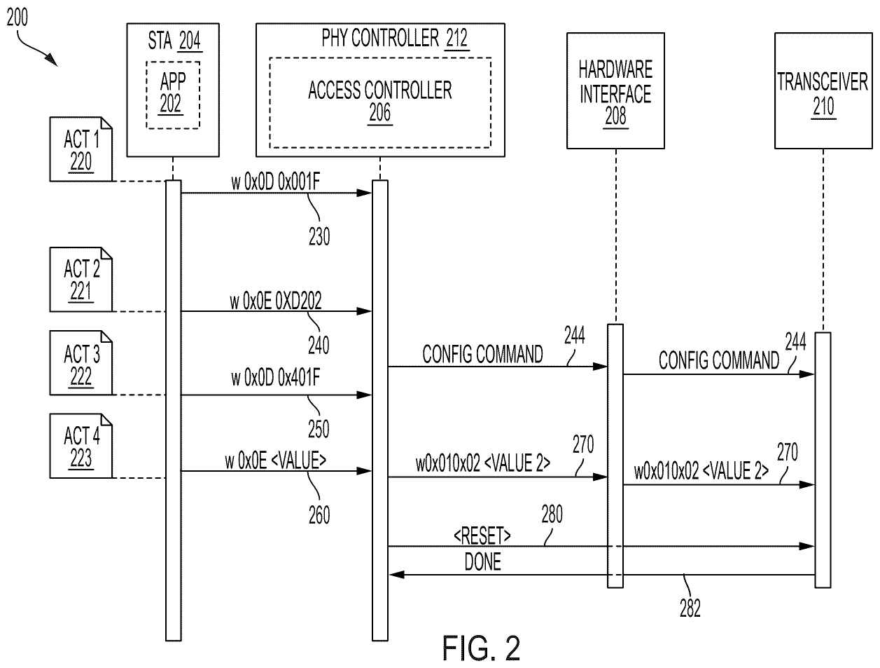

FIG. 2 is an interaction timing diagram that illustrates a timing diagram according to one or more examples. Timing diagram 200 is an application control transaction (ACT) timing diagram to show the timing interactions of network components including, without limitation, a station manager Ethernet controller (STA) 204, software applications or firmware APP 202 of the STA, a controller of a physical layer (PHY) or PHY controller 212, a hardware interface 208, and a transceiver 210. PHY 212 may include a controller 204, a hardware interface 208, and a transceiver 210. The transceiver 210 may be connected to the PHY controller 212 via the hardware interface 208. In one or more examples, PHY controller 212 may include an access controller 206.

The App 202 may use a bus protocol such as, without limitation, the C22 protocol or C45 protocol of the IEEE 802.3 standard, to access the PHY controller 212. The C22 protocol may enable the transfer of address and data within a single frame of an access operation, such as, without limitation a read or write operation. The C45 protocol may use at least two operational cycles for each access operation. In a access operation using the C45 protocol, the first two operational cycles may each be an address cycle that use up to 16 bits of address. One or more subsequent or additional cycle or cycles may write or send data or read or receive data depending on the access control operation or transaction selected. In one or more non-limiting examples, controller 204 may selectively activate, or otherwise utilize, a remapper 206 to convert a frame from a first protocol format to a second protocol format. Converting a frame may include, for example, without limitation, modifying or changing the address of data of the frame, or generating a substitute or different frame with a different address and different data. Hardware interface 208 may be a serial interface that is configured in compliance with an Ethernet IEEE 802.3 standard. For example, without limitation, hardware interface 208 may be, for example, without limitation, an MDIO, TC14 interface, or a media independent interface (MII) as defined according to the Ethernet IEEE 802.3 standards. The hardware interface 208 may also include a management data clock (MDC) (not shown) for managing transfer of data between PHY controller 212 and devices such as, without limitation, a transceiver 210.

In a Clause 45 or annex 22D protocol, the first two access cycles may be addressing cycles. In a non-limiting example, ACT 1 220, App 202 may send a first frame 230 to access controller 206 of PHY 212. In non-limiting examples of this disclosure, “w” may be used to denote a write access command and “r” may be used to denote a read access command. In the non-limiting example of FIG. 2, the access command of App 202 is a write access as denoted by the letter “w.” Starting with ACT 1 220, App 202 may send a write access to PHY 212.

At ACT 1, App 202 of the Station management (STA) writes a frame “0×0D 0×001F” 230 with register address 0×0D and device address 0×001F to controller 204. The access transaction 230 writes to register 0D (0×0D) a PHY device address of 001F (0×001F) or 1F. The PHY device address may be 16 bits. The write to register “0D” 230 indicates to PHY controller 212 that a register device address will follow in the next access.

At ACT 2 221, App 202 writes frame 0×0E 0×D202 240 with register address “0E” and register device address “0×D202.” App 202 writes to register “0E” (0×0E) a 16-bit register address “D202” 240. Since this address is in transceiver space, the access controller 206 changes the mode of the hardware interface 208 to MDIO via config command 244 and prepares a clause 22 transaction with the register address of the transceiver.

At ACT 3 222, the App 202 may send a write access command 250, which informs the access controller 206 that data in the registers of the transceiver 210 will be accessed in a subsequent operation. At ACT 4 223, the write access operation of ACT 2 may be converted through access controller 206 into a C22 protocol at the transceiver 210 so that the write or read data may be mirrored between the destination register of the transceiver 210 and the write to the PHY controller 212. For example, without limitation, at ACT 4 223, the write to register “0E” or “0×0E” 260, may result in a write to a register of transceiver 210 identified at ACT 2 221 after access controller 206 translates the address and/or data using C22 protocol to “0×01 0×02” 270. At ACT 4 223, a read access of “0E” is directed to the transceiver 210 and data of would be read from register “02.” At the end of ACT 4 223, the PHY controller 212 may send a reset 280 to the transceiver 210. In response to the reset 280, the transceiver 210 may send a done 282 signal to the PHY controller 212 to indicate termination of the process.

It should be recognized that the App 202 may optionally utilize timing delays between accesses. For example, without limitation, the App 202 may poll-for-completion or perform some other comparable delay event to wait for a transaction to complete its operation before requesting or starting another transaction or operation. Notably, specific timing considerations are not depicted in FIG. 2 to avoid obscuring the drawing with details that could necessarily depend on specific operating conditions.

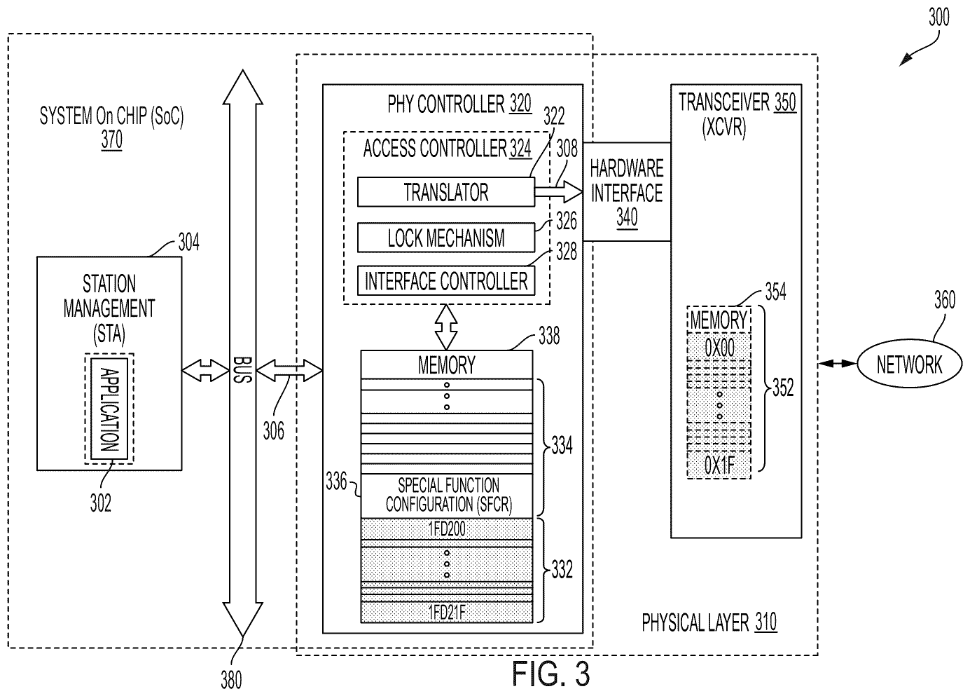

FIG. 3 is a diagram that illustrates a system including an Ethernet physical layer (PHY) apparatus in accordance with one or more examples. In FIG. 3, system 300 may include, for example, without limitation, a system-on-chip (SoC) 370. PHY 310 may include a digital portion of the PHY controller 320 that may be embedded in the SoC 370. The SoC 370 may include a station manager 304 Ethernet controller that may include firmware or software application 302 that may be executed by STA 304 to drive a frame 306 in an annex 22D format to the PHY controller 320 across a bus interface 380 to a memory 338 of the PHY controller 320. The memory 338 of the PHY controller 320 may include address space local to the PHY controller 334 and virtual address space 332 assigned to transceiver 350. The extended virtual address 332 may correspond to physical memory space in memory 354 assigned to a transceiver 350. The PHY controller 320 may, optionally, include a lock mechanism 326 to control whether or not access operations may be enabled to transceiver 350. Alternatively, a lock mechanism may be provided at transceiver 350. The lock mechanism is discussed further below.

It must be recognized that although only one PHY 310 is illustrated, the SoC 370 may be coupled to a number of PHYs in a multidrop configuration. Similarly, it must be noted that although only one transceiver 350 is illustrated as captive to the PHY controller 320 through hardware interface 340, PHY controller 320 may address a number of physical memory locations of one or more transceivers based on a unique address overlaid by the controller.

PHY controller 320 may configure hardware interface 340 (e.g., manage set up and adjustment of hardware interface 340 to operate according to specific requirements, without limitation). The PHY controller 310 may include a remapper 322. The remapper 322 may translate the address and data of a frame 304 accessing the PHY controller 320 utilizing an annex 22D protocol to address and data format of a frame 306 utilizing a clause 22 protocol.

The transceiver 350 is controlled by or captive to the controller 320 through hardware interface 340. The memory 354 of the transceiver 350 may include register locations 352 that mirror the extended registers 332 of memory 338 of the controller 320. The transceiver may input and/or output data to and from a network 360.

In one or more examples, application or App 302 of SoC 370 may be executed for an access operation to the PHY 310. The application 302 may be a software driver or station controller configured to send a frame 304 containing instructions and or data to the SoC 370 in a sequenced manner across a bus interface 380. In one or more examples, the App 302 may send an annex 22D frame 304 across bus interface 380. Bus interface 380 may be any interface designed to support a connection to a PHY such as, for example, without limitation, a media independent interface (MII), or reduced media-independent interface (RMII) with associated station management interface. The memory 338 of the PHY controller 320 may include virtual address spaces 334 local to the controller 320 and may also include extended virtual address spaces 332 that are assigned to physical locations 352 in a transceiver 350 that may be captive to the PHY controller 320. In examples of this disclosure, a transceiver that is captive to a controller is controlled by controller.

Application 302 may execute an access operation that may be a read operation or a write operation. The PHY controller 320 snoops the operation to determine the destination of the access based on the address. For example, without limitation, the controller 320 may snoop an access operation. If the access operation includes virtual addresses 13 and 14, the controller 320 determines if the operation requires access to the address space that is located in the physical memory of the transceiver 350.

The SoC 370 may access memory of the controller utilizing two address cycles in accordance with the protocol of annex 22D. The PHY controller 320 analyzes the addresses to determine whether the read or write access has an address that is within the register space of the controller or within the extended register space with register space located in the transceiver memory 354. An address that falls within the range of the extended registers 332 triggers the interface controller 328 of the access controller 320 to send a command to configure the hardware interface 340 to an MDIO/MDC mode. The PHY controller 320 may then write or read the transceiver register utilizing two data cycles in accordance with the protocol of annex 22D. After the data transfer is complete, the PHY controller 320 may reset the transceiver via the hardware interface 340.

The hardware interface 340 may be configured as an MDIO interface with an MDC clock of around 2.5 MHZ, which sends the remapped address and data payload in a clause 22 format to the designated memory location of the transceiver. It must be noted that although only one PHY transceiver is illustrated, the SoC 370 may be interfaced to a number of PHY transceivers connected in a multidrop bus configuration through hardware interface 340. The multidrop configuration is a feature of 10BASE-TIS automotive Ethernet technology and allows multiple devices to be connected to the same node. In one or more examples, the number of PHY transceivers may be equal to 32.

In a normal operating mode, the transceiver may operate to send data to and from network 360 through the hardware interface 340 of PHY transceiver 350. In one or more examples, hardware interface 340 may be configured to operate in one mode as a Management Data Input/Output (MDIO) with an MDIO Interface Clock (MDC). In one or more examples, hardware interface may operate in a data transfer mode, such as, without limitation, the Open Alliance PMD transceiver mode. Hardware interface 340 may be any interface designed to support a connection to a PHY such as, for example, without limitation, a media independent interface (MII), or reduced media-independent interface (RMII).

A configuration command may be issued from interface control of PHY controller 320 to configure the hardware interface 340 to operate in a Management Data Input/Output (MDIO) with an MDIO Interface Clock (MDC) to send address and data corresponding to register locations 352 of transceiver memory 354.

In one or more examples, the application 302 may send an access command to write to a location in both the PHY controller 320 and the transceiver 350, for example, without limitation, a topology discovery enable bit, to enable topology discovery. The application 302 may be executed to access the registers of the PHY controller 310 and the registers assigned to the transceiver 350. Addressing the transceiver registers 332 may trigger the access controller 320 to send a configuration command to the hardware interface 340 and may also trigger the translator 322 to remap the address and data to a clause 22 frame format 306 to access a topology discovery location of the transceiver MIRROR.

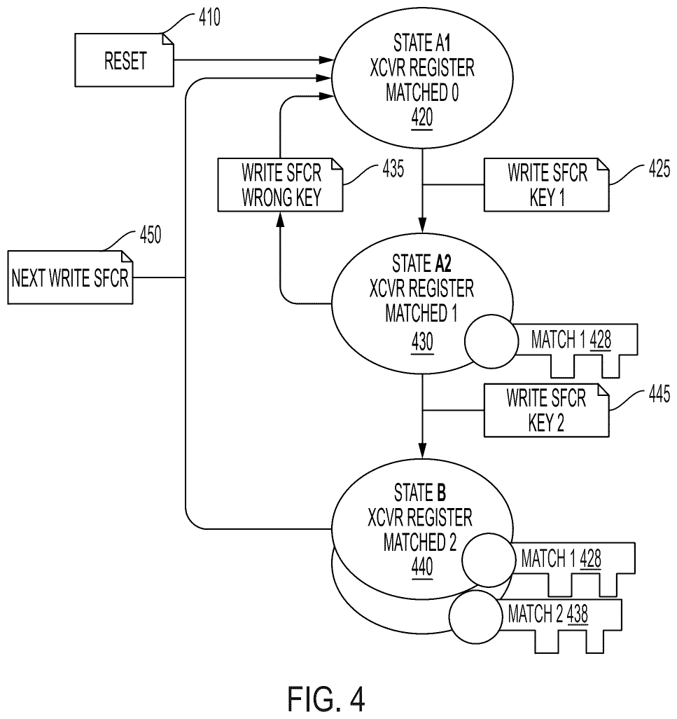

FIG. 4 is a state diagram that describes transitions that may occur to implement a locking mechanism according to one or more examples. It may be desirable that after configuration, the registers of the transceiver may need to be locked against inadvertent writes by the firmware. The memory of the controller of the PHY may include a special function configuration register (SFCR), such as SFCR 336 of FIG. 3, which may be configured through firmware to lock and unlock a set of write destination registers, such as, without limitation, transceiver (XCVR) registers. It is also possible that the transceiver registers may need to be unlocked and reconfigured, for example, without limitation, to perform diagnostics. In one or more examples, after a reset 410, the default state may be a locked state or an unlocked state based on the system or firmware configuration requirements. For example, without limitation, hardware may be configured to a default state that is a register unlocked state where writes to the transceiver registers are enabled, or a register locked state where writes to the transceiver registers are disabled. In the example of this disclosure, the default state is the unlocked state.

A change of state from an initial unlocked or locked state may be achieved by firmware writing a key, or series of keys, such as, without limitation, a software license key, into a special register, such as special function configuration register 336 (SFCR) of FIG. 3. Each key written to the register is checked against one or more values set or previously programmed into the device. In the example of this disclosure, after a reset 410, the firmware places the hardware in an initial State A1 XCVR Register Match 0 state where write accesses to the transceiver registers may be enabled since there are no key matches. At transition condition Write SFCR Key 1 425, the firmware may write a first value or key 1 to the SFCR. A match, Match 1 428, must be determined between key 1 and a preprogrammed key, to enable a change of state of the hardware to State A2 XCVR Register Match 1 430 state. In the example of this disclosure, it takes two correct keys written successfully to the SFCR in succession, that is, the key value written to the SFCR register matches a preprogrammed value, to change the state of the hardware from an initial locked to an unlocked state or from an initial unlocked to a locked state. Therefore, in this example, the registers of the transceiver remain in the unlocked state.

At transition condition 445, the firmware may write a second value or key 2 to the SFCR. A second successive and successful match, Match 2 438, determined between a preprogrammed key and key 2 may transition the hardware to a State B XCVR Register Match 2 440 where firmware may lock transceiver registers for writes since the initial state, State A1 XCVR Register Match 0, is an unlocked state. The hardware may remain in State B XCVR Register Match 2 440 until transition condition Next Write SFCR 450 where a subsequent write to the SFCR causes the hardware to change state and return to State A1 XCVR Register Match 0 420. In the example of this disclosure the state of the transceiver register at State B XCVR Register Match 2 440 persists until two successive match keys are written to the SFCR register. For example, it should be emphasized that in State A1 or State A2, the firmware may not change the state of the transceiver register, from locked to unlocked or unlocked to locked, remains unchanged until two successive correct keys are matched, for example, Match 1 428 and Match 2 438. In State A2 XCVR Register Match 1 430, a transition condition WRITE SFCR WRONG KEY 435 where a successive or subsequent write to the SFCR is a wrong or incorrect key may cause a state change of the hardware to return to an initial start state, State A1 XCVR Register Match 0 420. It should be noted that although in the examples of this disclosure, the default initial state of the registers of the transceiver may be unlocked, the firmware may be programmed to a starting default state of locked. However, the firmware or processor application, subject to programming, may not allow a change of status of the transceiver registers from locked to unlocked or locked to unlocked without, for example, without limitation, two successive key matches, Match 1 428 and Match 2 438.

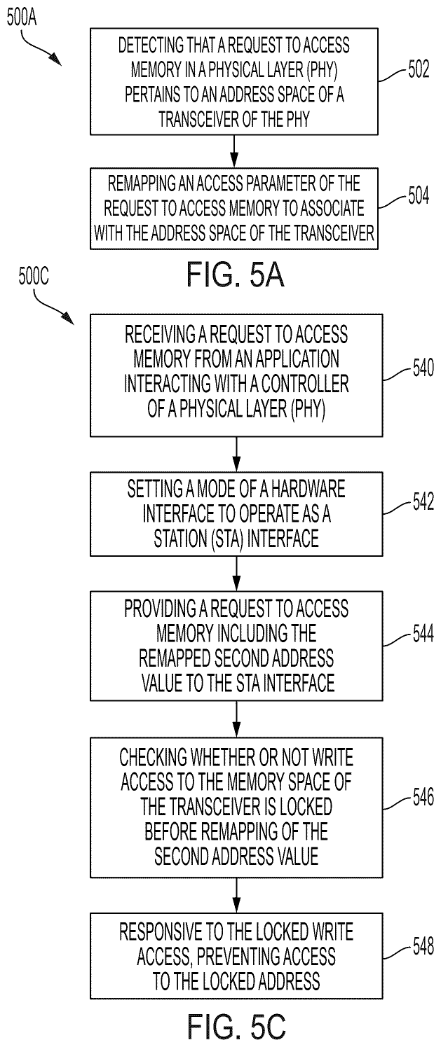

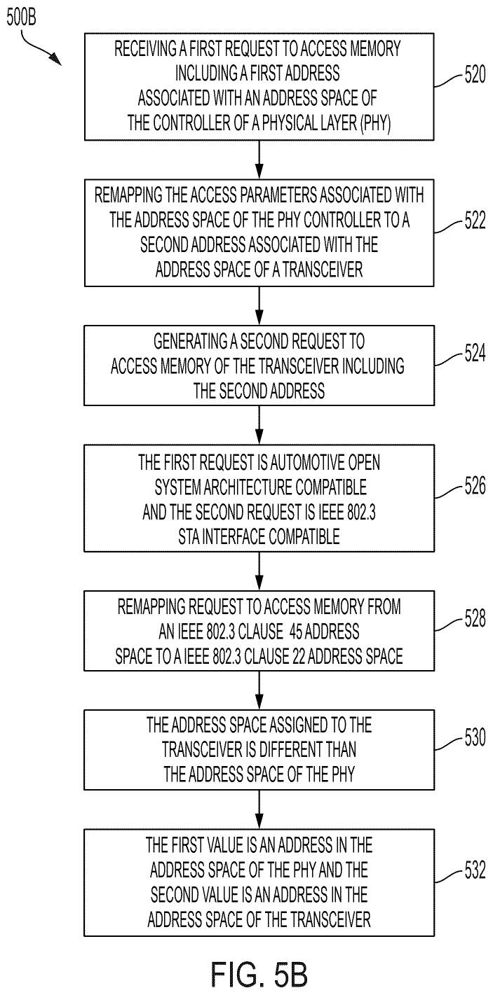

FIGS. 5A-5C are diagrams depicting a process of transceiver access using controller remapping in a split-PHY. Although the example processes of 500A-500C depict a particular sequence of operations, the sequence may be altered without departing from the scope of the present disclosure. For example, some of the operations depicted may be performed in parallel or in a different sequence that does not materially affect the function of the process. In other examples, different components of an example device or system that implements the processes 500A-500C may perform functions at substantially the same time or in a specific sequence. Some or a totality of operations of processes 500A-500C may be performed, for example, without limitation, by apparatus 100 or system 300.

In one or more non-limiting examples, FIG. 5A discloses a process 500A illustrating steps of acts for remapping or translating accesses to memory of a PHY. It should be noted that the sequence of the acts are not limited to the process described and other sequences or operations may be included as would be recognized by one of ordinary skill in the art. Process 500A may include act 502 of detecting that an access request pertains to an address space assigned to the transceiver of a physical layer. At act 504, the process includes translating an access parameter to associate with the address space assigned to the transceiver.

In FIG. 5B, the process 500B begins with an act 502 of receiving a first request to access memory including a first value remapping a first access to a second access of a PHY. The first address may be associated with an address space of a physical layer. At act 522, the process proceeds to map the access parameters associated with the address space of the PHY controller to a second value associated with the address space of the transceiver. At act 524, the process may generate a second request to access the memory including the second address. At act 526, it should be noted that the first access request may be compatible with a standardized automotive Ethernet software architecture, such as, without limitation, the Automotive Open System Architecture (AUTOSAR®) and the second access request may be IEEE 802.3 STA interface compatible. At act 528, the process may remap an access from an IEEE 802.3 Clause 45 address space to an IEEE 802.3 Clause 22 address space. At act 530, it may be noted that the extended address space assigned to the transceiver is different than the extended address space of the PHY. At act 532, it may be noted that the first address has a first value in the extended address space of the PHY and the second address has a second value in the extended address space assigned to the transceiver.

In FIG. 5C, process 500C may begin with an act 540 of receiving (e.g., a PHY may receive, without limitation) a request to access memory from an application interacting with a controller of a PHY. At act 542, the process proceeds to setting a mode of a hardware interface to operate as a station management (STA) interface. At act 544, the process may be providing a request to access memory including the remapped second address value to the STA interface. The process at act 546 may then begin checking whether or not a write access to the memory space of the transceiver is locked before remapping or translating the second address value. If the process determines that the write address is locked, at act 548, responsive to the locked write access, access to the transceiver register is prevented.

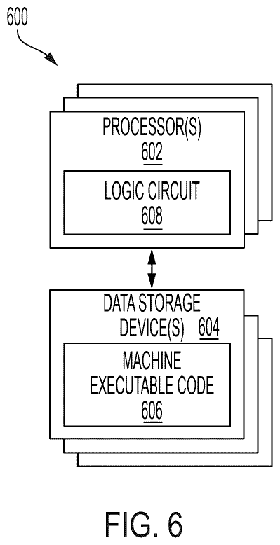

FIG. 6 is a system diagram in accordance with one or more examples. The system diagram 600, in some examples, may be used to implement various functions, operations, acts, processes, or methods disclosed herein. The circuitry 600 includes one or more processors 602 (sometimes referred to herein as “processors 602”) operably coupled to one or more data storage devices 604 (sometimes referred to herein as “storage 604”). The storage 604 includes machine executable code 606 stored thereon and the processors 602 include logic circuit 608. The machine executable code 606 information describing functional elements that may be implemented by (e.g., performed by) the logic circuit 608. The logic circuit 608 is adapted to implement (e.g., perform) the functional elements described by the machine executable code 606. The circuitry 600, when executing the functional elements described by the machine executable code 606, should be considered as special purpose hardware configured for carrying out functional elements disclosed herein. In some examples, the processors 602 may be configured to perform the functional elements described by the machine executable code 606 sequentially, concurrently (e.g., on one or more different hardware platforms), or in one or more parallel process streams.

When implemented by logic circuit 608 of the processors 602, the machine executable code 606 is configured to adapt the processors 602 to perform operations of examples disclosed herein. By way of non-limiting example, the machine executable code 606 may be configured to adapt the processors 602 to perform some or a totality of operations of one or more of detecting a request to access a portion of the extended registers in memory of the controller and remapping the address value of the request to associate with the address space of a transceiver of the PHY, wherein the extended memory pertains to the register space in memory of the transceiver.

Also by way of non-limiting example, the machine executable code 606 may be configured to adapt the processors 602 to perform some or a totality of features, functions, or operations disclosed herein.

The processors 602 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer, while the general-purpose computer is configured to execute functional elements corresponding to the machine executable code 606 (e.g., software code, firmware code, hardware descriptions) related to examples of the present disclosure. It is noted that a general-purpose processor (may also be referred to herein as a host processor or simply a host) may be a microprocessor, but in the alternative, the processors 602 may include any conventional processor, controller, microcontroller, or state machine. The processors 602 may also be implemented as a combination of computing devices, such as a combination of a DSP and a microprocessor, a plurality of microprocessors, one or more microprocessors in conjunction with a DSP core, or any other such configuration.

In some examples, the storage 604 includes volatile data storage, for example, without limitation, random-access memory (RAM), non-volatile data storage, for example, without limitation, flash memory, hard disc drive, solid state drive, erasable programmable read-only memory (EPROM). In some examples, the processors 602 and the storage 604 may be implemented into a single device, for example, without limitation, a semiconductor device product, or a system on chip (SoC), such as SoC 370 of FIG. 3. In some examples, the processors 602 and the storage 604 may be implemented into separate devices.

In some examples, the machine executable code 606 may include computer-readable instructions (e.g., software code, firmware code). By way of non-limiting example, the computer-readable instructions may be stored by the storage 604, accessed directly by the processors 602, and executed by the processors 602 using at least the logic circuit 608. Also by way of non-limiting example, the computer-readable instructions may be stored on the storage 604, transferred to a memory device (not shown) for execution, and executed by the processors 602 using at least the logic circuit 608. Accordingly, in some examples, the logic circuit 608 includes electrically configurable logic circuit 608.

In some examples, the machine executable code 606 may describe hardware (e.g., circuitry) to be implemented in the logic circuit 608 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, System Verilog or very large scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 608 may be described in an RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples, the machine executable code 606 may include an HDL, an RTL, a GL description, a mask level description, other hardware description, or any combination thereof.

In examples where the machine executable code 606 includes a hardware description (at any level of abstraction), a system (not shown, but including the storage 604) may be configured to implement the hardware description described by the machine executable code 606. By way of non-limiting example, the processors 602 may include a programmable logic device (e.g., an FPGA or a PLC) and the logic circuit 608 may be electrically controlled to implement circuitry corresponding to the hardware description into the logic circuit 608. Also by way of non-limiting example, the logic circuit 608 may include hard-wired logic manufactured by a manufacturing system (not shown, but including the storage 604) according to the hardware description of the machine executable code 606.

Regardless of whether the machine executable code 606 includes computer-readable instructions or a hardware description, the logic circuit 608 is adapted to perform the functional elements described by the machine executable code 606 when implementing the functional elements of the machine executable code 606. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means “some or a totality.” As used herein, the term “each and every” means a “totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

### Additional Non-Limiting Examples Include

Example 1: An apparatus comprising: a controller of the physical layer (PHY); and a transceiver of the PHY in communication with the PHY via a hardware interface, the PHY to translate a first value of an address associated with an address space of the PHY to a second value of an address associated with the extended address space of the transceiver.

Example 2: The apparatus according to Example 1, wherein the controller to: receive a first request to access memory including the first address value associated with the address space of the PHY; map the first address value associated with the address space of the PHY to the second address value associated with the extended address space of the transceiver; and generate a second request to access memory including the second address value.

Example 3: The apparatus according to Examples 1 and 2, wherein the first access is compatible with one of IEEE 802.3 Clause 22 annex D protocol, and wherein the second access is compatible with IEEE 802.3 Clause 22 protocol.

Example 4: The apparatus according to any of Examples 1 to 3, wherein the controller to: receive a first request to access an address space including the first address value associated with the address space of the PHY; remap the first address value associated with the address space of the PHY to the second address value associated with the address space assigned to the transceiver; and generate a second request to access memory including the second address.

Example 5: The apparatus according to any of Examples 1 to 4, wherein the first address is associated with a first access request that is compatible with an Automotive Open System Architecture and the second request is associated with a second access request that is station management (STA) interface compatible.

Example 6: The apparatus according to any of Examples 1 to 5, wherein controller to remap a request to access memory from a Clause 22 annex D frame format to a clause 22 frame format.

Example 7: The apparatus according to any of Examples 1 to 6, wherein the address space assigned to the transceiver is different than the address space of the PHY.

Example 8: The apparatus according to any of Examples 1 to 7, wherein the controller to remap the first address to associate with the address space assigned to the transceiver at least partially responsive to detection that the first access pertains to registers or functionalities of the transceiver.

Example 9: The apparatus according to any of Examples 1 to 8, wherein the controller, responsive to detection that the first address pertains to registers or functionalities of the transceiver, to remap the first address to a second address associated with the register space assigned to the transceiver.

Example 10: The apparatus according to any of Examples 1 to 9, wherein the controller to provide an STA interface for application-level interactions with the PHY, and the address space of the PHY is accessible by applications via the controller.

Example 11: The apparatus according to any of Examples 1 to 10, wherein the controller to remap data corresponding to the first address and transmit the remapped data to the address space associated with the second address.

Example 12: The apparatus according to any of Examples 1 to 11, comprising a station management (STA) interface, wherein the controller to configure the STA interface to pass the remapped second address and data through to the transceiver responsive to the detection that the first address is of the address space of the transceiver.

Example 13: The apparatus according to any of Examples 1 to 12, wherein the controller to initialize the STA interface to an MDIO interface or set the mode of the hardware interface to a media independent interface (MII).

Example 14: The apparatus according to any of Examples 1 to 13, wherein the controller to check whether or not write s locked at the register space of the transceiver before mapping of the first value of the address.

Example 15: The apparatus according to any of Examples 1 to 14, wherein the controller to detect that address is an access to the transceiver based on compliance with the IEEE protocol.

Example 16: A method, comprising: detecting that an access request pertains to an address space assigned to the transceiver of a physical layer (PHY); and remapping an access parameter of the access request to associate with the address space assigned to the transceiver.

Example 17: The method according to Example 16, comprising: receiving a first access having a first address, the first address associated with an address space of the PHY; remapping the first address to a second address, the second address associated with a second address space assigned to a transceiver of the PHY; and generating a second access to access the transceiver including the second address.

Example 18: The method according to Examples 16 and 17, wherein the first request is compatible with an Automotive Open System Architecture and the second request is IEEE 802.3 STA interface compatible.

Example 19: The method according to any of Examples 16 to 18, wherein the first access is based on an automotive Ethernet protocol and the second access is based on an Ethernet serial interface protocol.

Example 20: The method according to any of Examples 16 to 19, comprising remapping an access from an IEEE 802.3 clause 45 extended address space to an IEEE 802.3 clause 22 address space.

Example 21: The method according to any of Examples 16 to 20, wherein the address space assigned to the transceiver is different than the address space of the PHY.

Example 22: The method according to any of Examples 16 to 21, wherein the first address has a first value in the address space of the PHY and the second address has a second value in the address space assigned to the transceiver.

Example 23: The method according to any of Examples 16 to 22, comprising: receiving the access request from an application interacting with the PHY physical layer.

Example 24: The method according to any of Examples 16 to 23, comprising: setting a mode of a hardware interface to operate as a station management (STA) interface; and providing a request to access address space including the remapped second address value to the STA interface.

Example 25: The method according to any of Examples 16 to 24, comprising: checking whether or not a write access is locked at the address space assigned to the transceiver to prevent access to the transceiver address space.

Example 26: An apparatus, comprising: at least one processor; and a memory having instructions thereon that, when executed by the at least one processor, enable the processor to: detect that a request to access memory pertains to an address space assigned to the transceiver of a physical layer (PHY); and remap an address value of the request to associate with the address space assigned to the transceiver.

Example 27: A system, comprising: a bus interface to process an application-level interaction; a physical layer (PHY) coupled to the first bus interface, the PHY including: a controller; a transceiver captive to the controller; and a hardware interface between the controller and the transceiver to control access to the transceiver based on the application-level interaction; wherein a first address of an access to the PHY to generate a remapping to a second address that is part of the transceiver, wherein the first address and the second address causes an initialization of the hardware interface to generate an access to the transceiver, wherein the first address is part of an extended address space.

Example 28: The system according to Example 27, wherein responsive to detection that the first address includes an extended address, the controller to remap the first address to a second address, wherein the second address is a physical address space assigned to the transceiver.

Example 29: The system according to Examples 27 and 28, wherein a format of the first address is based on an automotive Ethernet protocol and a format of the second address is based on an Ethernet serial interface protocol.

Example 30: The system according to any of Examples 27 to 29, wherein the controller comprises remapper logic operable to generate a physical address remapped to correspond with an address space of the transceiver.

Example 31: The system according to any of Examples 27 to 30, comprising a memory of the PHY associated with the transceiver, wherein the memory comprises a plurality of registers to store data corresponding to the second address.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

One or more implementations have been described herein. Nevertheless, it will be understood that various modifications may be made. For example, advantageous results may be achieved if steps, acts or operations of the techniques discussed herein were performed in a different sequence, or if components of the disclosed systems were combined in a different manner, or if the components were supplemented with other components. Accordingly, other implementations are contemplated as may be determined by this disclosure.

What is claimed is:

1. An apparatus comprising:
a controller of a physical layer (PHY); and
a transceiver of the PHY in communication with the controller via a hardware interface, the PHY to translate a first value of an address associated with an address space of the PHY to a second value of an address associated with an address space of the transceiver.

2. The apparatus of claim 1, wherein the controller to:
receive a first request to access memory including the first address value associated with the address space of the PHY;
map the first address value associated with the address space of the PHY to the second address value associated with the address space of the transceiver; and
generate a second request to access memory including the second address value.

3. The apparatus of claim 2, wherein the first access is compatible with one of IEEE 802.3 Clause 22 annex D protocol, and wherein the second access is compatible with IEEE 802.3 Clause 22 protocol.

4. The apparatus of claim 1, wherein the controller to:
receive a first request to access an address space including the first address value associated with the address space of the PHY;
remap the first address value associated with the address space of the PHY to the second address value associated with the address space assigned to the transceiver; and
generate a second request to access memory including the second address.

5. The apparatus of claim 4, wherein the first address is associated with a first access request that is compatible with an Automotive Open System Architecture and the second request is associated with a second access request that is IEEE 802.3 station management (STA) interface compatible.

6. The apparatus of claim 4, wherein controller to remap a request to access memory from a Clause 22 annex D frame format to a clause 22 frame format.

7. The apparatus of claim 4, wherein the address space assigned to the transceiver is different than the address space of the PHY.

8. The apparatus of claim 4, wherein the controller to remap the first address to associate with the address space assigned to the transceiver at least partially responsive to detection that the first access pertains to registers or functionalities of the transceiver.

9. The apparatus of claim 5, wherein the controller, responsive to detection that the first address pertains to registers or functionalities of the transceiver, to remap the first address to a second address associated with a register space assigned to the transceiver.

10. The apparatus of claim 1, wherein the controller to provide an STA interface for application-level interactions with the PHY, and the address space of the PHY is accessible by applications via the controller.

11. The apparatus of claim 7, wherein the controller to remap data corresponding to the first address and transmit the remapped data to the address space associated with the second address.

12. The apparatus of claim 8, comprising a station management (STA) interface, wherein the controller to configure the STA interface to pass the remapped second address and data through to the transceiver responsive to the detection that the first address is of the address space of the transceiver.

13. The apparatus of claim 9, wherein the controller to initialize the hardware interface to an Open Alliance TC14 PMD protocol or an IEEE 802.3 clause 22 protocol.

14. The apparatus of claim 1, wherein the controller, before remapping of the first value of the address, to determine if a write to the register space of the transceiver is locked.

15. The apparatus of claim 1, wherein the controller to detect that address is an access to the transceiver based on compliance with the IEEE protocol.

16. A method, comprising:
detecting that an access request pertains to an address space assigned to a transceiver of a physical layer (PHY); and
remapping an access parameter of the access request to associate with the address space assigned to the transceiver.

17. The method of claim 16, comprising:
receiving a first access having a first address, the first address associated with an address space of the PHY;
remapping the first address to a second address, the second address associated with a second address space assigned to the transceiver of the PHY; and
generating a second access to access the transceiver including the second address.

18. The method of claim 17, wherein the first request is compatible with an Automotive Open System Architecture and the second request is IEEE 802.3 STA interface compatible.

19. The method of claim 16, wherein the first access is based on an automotive Ethernet protocol and the second access is based on an Ethernet serial interface protocol.

20. The method of claim 17, comprising remapping an access from an IEEE 802.3 clause 45 address space to an IEEE 802.3 clause 22 address space.

21. The method of claim 17, wherein the address space assigned to the transceiver is different than the address space of the PHY.

22. The method of claim 17, wherein the first address has a first value in the address space of the PHY and the second address has a second value in the address space assigned to the transceiver.

23. The method of claim 16, comprising:
receiving the access request from an application interacting with the PHY physical layer.

24. The method of claim 16, comprising:
setting a mode of a hardware interface to operate as a station management (STA) interface; and
providing a request to access address space including a remapped second address value to the STA interface.

25. The method of claim 16, comprising:
checking whether or not a write access is locked at the address space assigned to the transceiver to prevent access to the transceiver address space.

26. An apparatus, comprising:
at least one processor; and
a memory having instructions thereon that, when executed by the at least one processor, enable the processor to:
detect that a request to access memory pertains to an address space assigned to a transceiver of a physical layer (PHY); and
remap an address value of the request to associate with the address space assigned to the transceiver.

27. A system, comprising:
a bus interface to process an application-level interaction;
a physical layer (PHY) coupled to the first bus interface, the PHY including:
a controller;
a transceiver captive to the controller; and
a hardware interface between the controller and the transceiver to control access to the transceiver based on the application-level interaction;
wherein a first address of an access to the PHY to generate a remapping to a second address that is part of the transceiver, wherein the first address and the second address causes an initialization of the hardware interface.

28. The system of claim 27, wherein responsive to detection that the first address includes an address, the controller to remap the first address to a second address, wherein the second address is a physical address space assigned to the transceiver.

29. The system of claim 28, wherein a format of the first address is based on an automotive Ethernet protocol and a format of the second address is based on an Ethernet serial interface protocol.

30. The system of claim 29, wherein the controller comprises remapper logic operable to generate a physical address remapped to correspond with an address space of the transceiver.

31. The system of claim 30, comprising a memory of the PHY associated with the transceiver, wherein the memory comprises a plurality of registers to store data corresponding to the second address.
